(19) United States
(12) Patent Application Publication
(10) Pub. No.: US 2025/0265300 A1
(43) Pub. Date: Aug. 21, 2025

(54) PARSING SEARCH RESULTS

(71) Applicant: Brightedge Technologies, Inc., Foster City, CA (US)

(72) Inventors: Lemuel S. Park, Foster City, CA (US); Sammy Yu, San Mateo, CA (US); Jimmy Yu, Foster City, CA (US); Albert Marc Gouyet, Palo Alto, CA (US); Lalith Maddali, Foster City, CA (US); Thomas J. Ziola, Menlo Park, CA (US); Ken Schults, Foster City, CA (US)

(21) Appl. No.: 19/056,695

(22) Filed: Feb. 18, 2025

Related U.S. Application Data
(60) Provisional application No. 63/554,924, filed on Feb. 16, 2024.

(51) Int. Cl. G06F 16/9538

(52) U.S. Cl. CPC G06F 16/9538

(57) ABSTRACT

A method of parsing search results may include rendering a search engine results webpage obtained in response to a request that includes one or more keywords. The method may include waiting a period for receipt of AI content to be presented on the search engine results webpage after the webpage is rendered but before analyzing it. The method may include navigating the webpage to interact with the AI content after receipt of the AI content. The method may include analyzing the AI content to determine characteristics of the AI content after navigation. One or more webpages associated with the one or more keywords may be adapted based on the characteristics of the AI content.

### CROSS-REFERENCE TO RELATED APPLICATIONS

This application claims priority to U.S. Provisional Patent Application No. 63/554,924 filed on Feb. 16, 2024, which is incorporated herein by reference in its entirety.

### BACKGROUND

Search engine optimization (SEO) may be a crucial aspect of digital marketing strategies. Webpages may be designed and optimized to improve their visibility and ranking in search engine results pages. The performance of webpages in search results may impact their ability to attract organic traffic and potential customers.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method of parsing search results may include rendering a search engine results webpage obtained in response to a request that includes one or more keywords. The method may include waiting a period for receipt of AI content to be presented on the search engine results webpage after the webpage is rendered but before analyzing it. The method may include navigating the webpage to interact with the AI content after receipt of the AI content. The method may include analyzing the AI content to determine characteristics of the AI content after navigation. One or more webpages associated with the one or more keywords may be adapted based on the characteristics of the AI content.

### BRIEF DESCRIPTION OF THE DRAWINGS

Example embodiments will be described and explained with additional specificity and detail through the use of the accompanying drawings in which:

FIG. 1 shows an environment illustrating components of a computing system for parsing search results.

FIG. 2 depicts a flowchart of an example method for parsing AI-generated search results.

FIG. 3 illustrates a flowchart to capture AI content in search results.

FIG. 4 presents a diagram showing how collected AI content data may be utilized.

FIG. 5 illustrates a flowchart for an example method to parse search results.

FIG. 6 depicts a block diagram of an example computing system for implementing the described methods.

### DESCRIPTION OF EMBODIMENTS

Internet search is a massive and growing channel for marketers. Performance in internet search may determine visitor traffic to websites from desktop, tablet, and mobile devices, such as handheld, car, etc., for a significant portion of business-to-consumer (B2C) and business-to-business (B2B) audiences for websites. One key to this performance is how well marketers' content performs on leading search engines, such as Google, Bing, and others and involving artificial intelligence (AI) technologies including PerplexityAI, ChatGPT, Microsoft Copilot, Claude2, Gemini/Bard, etc. Content performance on search engines (and input from a search optimization platform which can reveal insights about AI-structured search results), in turn, may also impact traffic from social media channels and influence marketers' decisions about investments in other channels and marketing platforms such as automated content optimization systems, video/image/audio media, marketing automation, paid media, content marketing platforms, chatbots, ABM platforms, content management systems, personalization platforms, customer loyalty systems, customer support systems, ecommerce systems, etc.

A recurring challenge for marketers is that internet search engines, such as Google, Bing, and others, change their internet search algorithms frequently as well as the structure, components, appearance, and various other aspects of Search Engine Results Pages (SEPRs). These algorithm and structural changes may impact what SERPs look like, search performance metrics (rankings, volumes, locations, etc.) of marketers' content in those SERPs, and/or the performance of paid search advertising. Sometimes these changes are small/nearly undetectable. From time to time, however, these changes may be very large scale and have much more significant impact on search results. SERP performance therefore may have a critical impact on business performance.

Over the last 25 years, several such critical shifts in internet search results have occurred. For example, internet SERPs have evolved from ten traditional blue links, to later include “universal” search results, carousel search, purchase links directly to ecommerce sites, visual search variation for mobile vs desktop display, local packs, etc. With each such critical shift, Search Engine Optimization (SEO) technology providers typically make changes to their technology to modify or otherwise adapt or evolve their systems to provide marketers with updated systems intended to enable marketers' content to maximize their content perform. Most recently changes are being triggered by the introduction of AI-generated search. AI-generated search may be used to enhance search results obtained from internet search queries. For example, AI-generated search may refer to search results that are curated, summarized, or directly created by artificial intelligence instead of just listing links to web pages. For example, AI-generated search may be used by search engine companies to provide enhanced results not only for specific keywords, but also for questions and questions that may be related to searched keywords and other types of related information that a user might have interest, as determined by AI or by AI combined with search engine algorithms or by interactive elements of the SERP itself.

For example, an AI-generated search result may include a direct answer to a question, a summary of relevant information from multiple sources, or a synthesized explanation of a complex topic. As another example, an AI-generated search result may take the form of a featured snippet at the top of a search engine results page. This snippet may provide a concise answer to the user's query, extracted and summarized from relevant web pages. The AI system may analyze multiple sources to generate this snippet, helping with accuracy and comprehensiveness.

As another example, AI-generated search may involve the creation of a custom paragraph or article in response to a user's query. Instead of simply providing links, the AI-generated search may synthesize information from various sources to create a unique, coherent response tailored to the specific question. This response may include relevant facts, explanations, and even examples to provide a more complete answer.

As another example, AI-generated search may also manifest as interactive elements within search results. For instance, the AI may generate a conversational interface that allows users to ask follow-up questions or request clarifications on the initial search results. This interactive element may provide a more dynamic and personalized search experience.

As another example, AI-generated search results may include visual elements such as charts, graphs, or infographics created by the AI to illustrate complex data or concepts related to the search query. These visual aids may be generated on-the-fly based on the most current information available, providing users with up-to-date and easily digestible content.

As another example, AI-generated search may also extend to multimedia content. For example, the AI may generate or curate video summaries, audio clips, or image galleries relevant to the user's query, providing a rich, multi-modal search experience. As another example, the AI-generated search may involve the creation of comparative analyses or pros-and-cons lists for queries that involve decision-making or product comparisons. The AI may synthesize information from various sources to present a balanced overview of different options or perspectives.

As another example, in the context of academic or scientific queries, AI-generated search results may include automatically generated literature reviews or research summaries. These summaries may compile key findings from multiple studies or papers, providing researchers with a comprehensive overview of a particular topic.

As another example, AI-generated search may also incorporate real-time data processing capabilities. For instance, for queries related to current events or rapidly changing situations, the AI may generate up-to-the-minute reports by analyzing and synthesizing information from various news sources and social media platforms.

As another example, AI-generated search may involve personalized content creation. The AI may take into account the user's search history, preferences, and context to generate search results, such as links to one or more websites, that are tailored to the individual's needs and interests, providing a more relevant and engaging search experience.

Systems and method described in this disclosure are directed to improvements in Search Engine Optimization (SEO) systems to enable SEO performance for content for that is impacted by the introduction of AI-powered internet search results. The systems and method described in this disclosure may help entities to improve organic search results as well as to improve paid search performance optimization, personalization, and performance in other marketing channels and provide data that can be input into other marketing platforms that can utilize such data in the process of delivering their functionality.

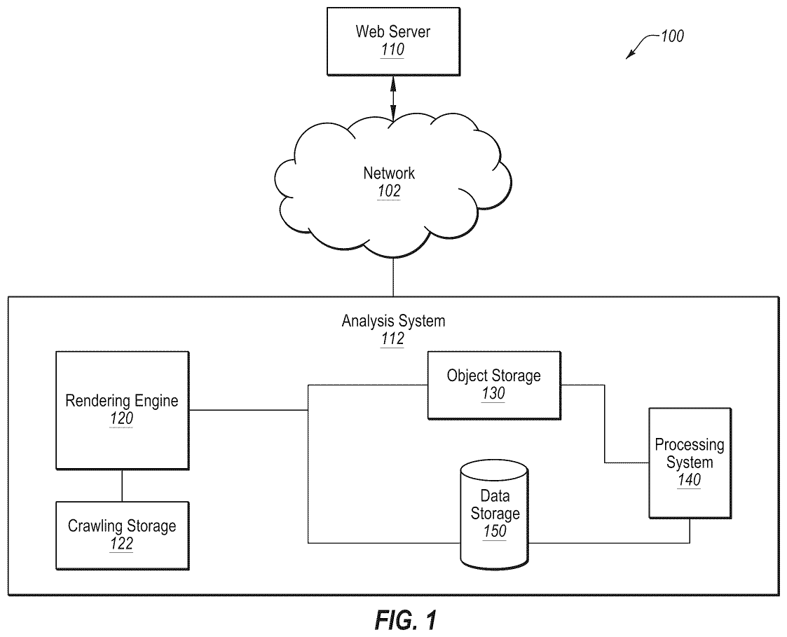

Turning to the figures, FIG. 1 illustrates an example environment 100 for parsing of search results. The environment 100 may be arranged in accordance with at least one embodiment described in the present disclosure. The environment 100 may include a network 102, a web server 110, a analysis system 112 that includes a rendering engine 120, crawling storage 122, object storage 130, processing system 140, and data storage 150.

In some embodiments, the network 102 may be any network or configuration of networks configured to send and receive communications between systems and devices. In some embodiments, the network 102 may include a wired network, an optical network, and/or a wireless network, and may have numerous different configurations, including multiple different types of networks, network connections, and protocols to communicatively couple devices and systems in the environment 100.

In some embodiments, the rendering engine 120 and/or the processing system 140 may include any configuration of hardware, such as processors, servers, database servers, and data storage that are networked together and configured to perform a task as described in this disclosure. For example, the rendering engine 120 may include one or multiple computing systems, such as multiple servers that each include memory and at least one processor.

In some embodiments, the rendering engine 120 may be configured to render webpages. For example, a webpage may be rendered by turning the HTML, CCS, and JavaScript code into an interactive webpage that a website user expects to see when accessing a webpage.

In some embodiments, the rendering engine 120 may be configured to query a web server 110 for a webpage associated with that a website hosted by the web server 110 and to render the webpage. For example, the website may be a search engine website or another website. The rendering engine 120 may be configured to request a webpage from the web server 110 over the network 102. For example, the rendering engine 120 may send a request to the web server 110 for the webpage for which a user may input a search into the website. In some embodiments, the website may be any type of search engine or website that requests an input and provides feedback based on the input. For example, the website may include Google, Bing, Perplexity AI, ChatGPT, Microsoft Copilot, Claude2, Gemini/Bard, among other types of websites.

In some embodiments, the rendering engine 120 may determine the website to access based on data from the crawling storage 122. The crawling storage 122 may include one or more crawling instructions that each include a website and one or more keywords that may be included in a request provided to the website. Each of the keywords may be a single word, image, or sound or a combination of words, images, and sounds. For example, a keyword may used with one or more other words that form a request, such as a question or phrase. The crawling instructions may also include information regarding profile data that may be provided to the website with each of the keywords. The profile data may be used by the website to determine a particular webpage or search results to provide in response to a query. For example, the profile data may include a country, city, persona, search history, personal demographics, etc., associated with the query.

In some embodiments, the rendering engine 120 may obtain a crawl instruction. Based on the crawl instructions, the rendering engine 120 may access a website and may present the profile data for the website to intake. For example, the rendering engine 120 may transmit the profile data to the website through an API or other communication protocol. The website may then process the profile data using algorithms or rules to determine which results to display and in what order. In some embodiments, the profile data may be updated in real-time as the rendering engine 120 interacts with the website, allowing for dynamic adjustment of the selected results. The rendering engine 120 may also include privacy controls to manage what profile data is shared with websites.

The rendering engine 120 may input a request into the website using a keyword included in the crawl instructions. The website may provide a webpage, such as a search engine results page, in response to the request. The content of the webpage may be based on one or more of the one or more keywords provided and the profile data. For example, webpage may be search engine results page and the profile data may include various attributes such as country, city, persona, search history, and personal demographics. For instance, a user in New York City searching for “best restaurants” may receive different search results compared to a user in Los Angeles performing the same search. In these and other embodiments, the search engine may take into account the user's location (e.g., New York City) when generating the search results. The results page may prioritize restaurants located in New York City or its surrounding areas. Additionally, the search engine may consider a search history from the profile data. In response to the search history include information regarding previously searched for or visited pages related to Italian cuisine, the search results may include a higher proportion of Italian restaurants. In some embodiments, demographic information from the profile data may also influence the search results. For example, in response to the profile data indicating a young professional, the search results may feature trendy, upscale restaurants that are popular among that demographic. Conversely, in response to the profile data indicating a parent with young children, family-friendly restaurants may be given more prominence in the results. In this way, the content of the search results page may be dynamically generated based on a combination of the keyword entered by the user and the various elements of their profile data. This personalized approach may aim to provide more relevant and useful results to each individual user based on their specific context and preferences.

In some embodiments, the rendering engine 120 may render the webpage fully as a browser would as if a user had requested the webpage. Alternately or additionally, the rendering engine 120 may be configured to interact with the webpage in a manner that a user may interact with the webpage such that JavaScript and other elements of the webpage that may not be activated without input are activated by the rendering engine 120.

In some embodiments, the webpage may include a request to obtain AI content from an AI model. The AI content may be generated in response to a request for a webpage and/or in response instructions in the webpage when the webpage is being rendered by a browser or other rendering engine. For example, the web server 110 when providing a webpage to a requesting device may send a request to an AI model for a response. The web server 110 may later provide the response from the AI model to the webpage as the webpage is rendered. As another example, code for rendering the webpage may be provided to the rendering engine 120 from the web server 110. The code when being rendered by the rendering engine 120 may send a request to an AI model for a response and the AI model may provide the response to the rendering engine 120.

Generally, AI models may be formed using the multiple different architectures. For example, many AI models use a transformer architecture that changes an input sequence, e.g. a request, into an output sequence, e.g. a response. Due to the complexity of the processing, AI models may not generate results that can be provided to the rendering engine 120 in a time frame that is typical for elements that may be presented on the page and sourced from other systems. For example, the results from AI may not be available for 0.5, 1, 2, 3, 4, 5, 10, 15, or more seconds, which could be longer than typical processing times for obtaining information typically presented on a webpage.

In some embodiments, the rendering engine 120 may be configured to pause and wait for the AI response to be received. In some circumstances, systems may attempt to render webpages quickly to optimize processing and allow for data gathering in an efficient manner. However, due to the increasing use of AI response with respect to search engine results pages, the rendering engine 120 may be configured to wait for the AI response to fully be received. Alternately or additionally, the rendering engine 120 may be configured to interact with the AI response to allow the AI views to be fully rendered.

In some embodiments, the rendering engine 120 may thus wait for a period for the AI response. In these and other embodiments, the rendering engine 120 may wait for a set period for all AI responses. Alternately or additionally, the period may be randomly generated. Alternately or additionally, the rendering engine 120 may wait until a response is begun to be received and then wait for a period until no further data is being received from the response to determine that the response is fully received. Alternately or additionally, the period may be determined based on historical times to receive responses. For example, the rendering engine 120 may have a longer set time initially to ensure that an AI response may be received. The rendering engine 120 may note the timing for receiving responses. In these and other embodiments, the rendering engine 120 may select a period in the future based on the mathematically combination of the response times.

Alternately or additionally, the rendering engine 120 may be configured to determine a period based on historical times for related queries sent to the AI model. For example, the rendering engine 120 may monitor response times for multiple different categories of queries. Based on the category of a request sent to the AI model, the rendering engine 120 may determine a response time window that is appropriate to wait while rendering a webpage. The category of a request may include a number of characters or words in the request, a topic of the request, and/or a location associated with the request. For example, the rendering engine 120 may determine a first wait time for the first request that is a first length and a first category and may determine a second wait time for a second request that is a second length and a second category.

In some embodiments, after the rendering engine 120 waits for the AI response to be fully received, the rendering engine 120 may be configured to navigate the webpage to interact with the AI response. To interact with the AI response, the rendering engine 120 may be configured to detect the AI response. In some embodiments, the rendering engine 120 may use a variety of ways to detect an AI response, including: (a) detecting if a webpage which asks if additional information of some kind is wanted. For example, if a question is being asked, the webpage may suggest “click here to see an AI generated answer to your question”); detecting if there is an element of the webpage that indicates that there is generative AI information related to the request and the AI-generated information is illustrated in or alongside the other elements of the webpage's content; detecting whether a webpage asks if the search engine should show more options (such as “show more” or that suggests follow-up questions generated by the search engine); applying JavaScript to a webpage to navigate the webpage to detect elements such as the above and/or follow indicated paths to AI response associated with the query experience. Alternately or additionally, the rendering engine 120 may insert and run JavaScript on the webpage and wait to see the indicators of AI content such as text pattern, Explicit Generate AI button, show more button etc. Alternately or additionally, the rendering engine 120 may detect AI content or additional AI content based on hierarchical and visually visible elements left on the search generative experience block provided by the webpage to determine if there are additional AI elements. The generative experience block may be identified using regular expressions, XML path language patterns in the nodes or node-sets in the webpage code, and CSS styles and IDs.

For example, an AI response may the rendering engine 120 may be configured to select one or more elements associated with the AI response to expand the AI response. By expanding the AI response, the rendering engine 120 may be configured to obtain all the AI response and not just a portion or summary of the AI response. In some embodiments, rendering a webpage with AI generated content may include reviewing for specific items like “show more options” and specific sections that need to be expanded. Alternately or additionally, rendering a webpage with AI generated content may include clicking on related questions and/or interacting with the AI being asking additional questions to clarify the AI response. For example, the rendering engine 120 may be configured to generate a follow-up question based on the AI response and provide the question to the AI. As a result, additional AI responses may be generated and collected by the rendering engine 120. In short, rendering a webpage with AI may include making decisions of moving between steps based on a current rendering and results that occur and not using a set algorithm that is the same for each webpage that is rendered. Thus, when rendering a first webpage resulting from a first keyword and first profile data, the rendering engine 120 may perform first operations and when rendering a second webpage resulting from a second keyword and second profile data, the rendering engine 120 may perform second operations that are different from the first operations.

In some embodiments, the rendering engine 120 may follow the procedures described in this disclosure to thereby capture an image of a fully rendered webpage. The image of the fully rendered webpage may be used in this disclosure to describe the webpage fully rendered as would be viewed by a human when navigating and interacting with the webpage with all the elements and data of the webpage available for processing.

In some embodiments, the rendering engine 120 may use one or more of the concepts described to determine if the webpage may include an AI response before waiting for the AI response. For example, the rendering engine 120 may use hierarchical and visually visible elements, inserted and run JavaScript, among others to determine if the webpage may include an AI response before waiting for the AI response.

The rendering engine 120 may provide the data to the data storage 150. Alternately or additionally, the rendering engine 120 may provide the image to the object storage 130. The object storage 130 may be configured to store the image for further processing and inspection.

In some embodiments, the processing system 140 may be configured to obtain the image from the object storage 130 and process the image to obtain data about the webpage reflected in the image. For example, the processing system 140 may be configured to parse the image to categorize the elements presented on the webpage and the response generated by the AI module. In this example, the processing system 140 may be configured to determine an amount of the webpage that is covered by the AI response and other webpage elements such as organic search results, paid search results, social media posts, images, among other webpage elements. For example, in some embodiments, the processing system 140 may be further configured to perform pixel-by-pixel parsing of the webpage to determine an amount of the webpage that is covered by the AI response and other webpage elements such as organic search results, paid search results, social media posts, images, among other webpage elements. Thus, the data of the webpage may indicate an amount of the webpage that is covered by different aspects of the webpage.

Alternately or additionally, the processing system 140 may be configured to analyze the AI response to further categorize or classify the AI response. For example, the processing system 140 may be configured to determine a characteristic of the AI response such as aa sen category or classification of the AI response. The categories/classification of the AI response may include the response indicating a place, a business, a particular store of a business (e.g., a Home Depot in a first location), an unordered list, an ordered list, pros and cons related to the query, reviews, shopping carousel, among other categories/classifications. The processing system 140 may also determine other aspects of the AI response. For example, the processing system 140 may determine one or more brands indicated in the AI response, a sentiment regarding one or more brands in the AI response, any sources indicated by the AI response, and/or a general answer provided by the AI response.

In some embodiments, the processing system 140 may correlate the elements and the response with the keywords and the profile data provided to the web server 110 that resulted in the webpage image generated by the rendering engine 120. As a result, the processing system 140 may understand how AI may respond to keywords and profile data. For example, the processing system 140 may determine what type of keywords and profile data results in different types of AI response and how are the search result pages affected by AI response.

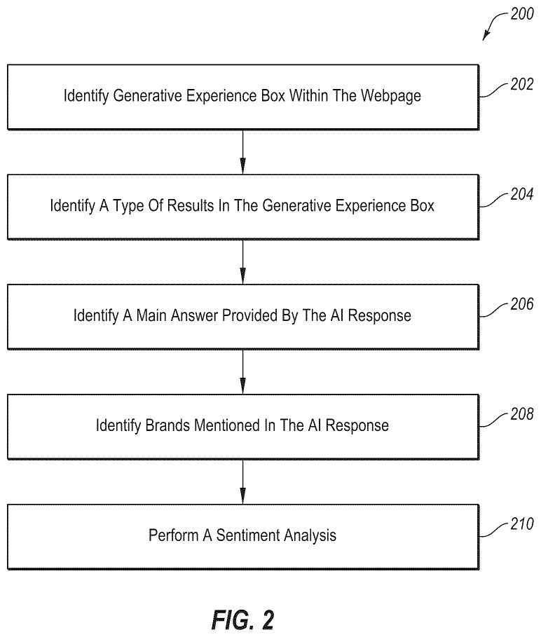

Based on this information, the processing system 140 may determine how AI may affect how search results pages handle keywords. For example, keywords that previously may have resulted in a search result page with a listing of first webpage may now provide a different search result page that may make the keyword more or less valuable. Using the data gathered from the rendering engine 120, the processing system 140 may determine keywords and/or profile data that may result in the different categories of AI responses. For example, the processing system 140 may use the keywords and AI responses from the rendering engine 120 to determine a correlation between keywords and AI responses. Thus, the processing system 140 may determine a type of keyword that may result in a particular category of AI response. Furthermore, the processing system 140 may determine how an AI response resulting from a particular keyword may provide information about an entity, such as a business, organization, and/or individual. Further details regarding gathering information regarding an entity is provided with respect to FIG. 2. Alternately or additionally, the processing system 140 or another engine may determine how AI may affect particular industries with respect to search results. For example, the processing system 140 may determine that AI may affect search results for the travel industry more than search results for consumer electronics. Alternately or additionally, the processing system 140 or another engine may determine how AI may affect internet traffic related to webpages based on search result pages, among other types of information such as determining whether the search engine is using a longer-form of a keyword than initially provided to the search engine.

In some embodiments, all the data generated by the processing system 140 may be provided to the data storage 150. In some embodiments, the data in the data storage 150 may be further analyzed to determine further information about how AI is affecting search result pages or to determine any of the information determined by the processing system 140.

In some embodiments, the data stored in the data storage 150 may be used as input for multiple other systems and/or modules. For example, the data stored in the data storage 150 may be used as input to a marketing system that enhances existing page content and features. For example, the data may be input to a system that modifies content and/or features on webpages visible to end-users and to search engines. The content may be modified to increase a marketing performance or compliance purposes of a webpage (where “compliance” includes objectives associated with website accessibility, privacy, or corporate governance, etc.). In these and other embodiments, the system may automatically generate changes to existing webpages or, proposes changes that marketers can review and authorize before appearing on a webpage.

Alternately or additionally, the data stored in the data storage 150 may be used to recommend or create content for A/B testing systems, chatbots, marketing automation systems, paid advertising systems, content marketing platforms, customer support systems, personalization systems, etc. to improve performance or the end-user customer experience. Alternately or additionally, the data provided by the AI response may be compared against a cited source of the data. In these and other embodiments, an accuracy of the AI response may be determined. In these and other embodiments, accuracy of the AI response may be determined for different categories, over various time frames, with respect to different personas, locations, and/or with respect to any other variable discussed in this disclosure.

As another example, the data stored in the data storage 150 may be used as input to generates new webpage content and/or features. For example, the data may be used to generate “content briefs” and “drafts” of text content for webpages. As another example, the data stored in the data storage 150 may be used as input to an AI module that assists a marketer to enhance specific page content components or features. For example, the system may use the data stored in the data storage 150 to generate title tags, image tags, schema, or other webpage components.

As another example, the data stored in the data storage 150 may be used as input to an A/B testing system (sometimes called an “Experimentation” system). Such A/B testing systems may involve testing the performance of different treatments/variants of webpage content or features with different audience segments to determine better configurations for various customer segment conversion performance.

As another example, the data stored in the data storage 150 may be used as input to enhance existing and/or new page content and features or for split testing may use AI to generate such enhancements.

Modifications, additions, or omissions may be made to the environment 100 without departing from the scope of the present disclosure. For example, in some embodiments, the environment 100 may include more or fewer components. For example, the environment 100 may not include the processing system 140. In these and other embodiments, the rendering engine 120 may perform the functions of the processing system 140.

FIG. 2 illustrate a webpage analysis flow 200. The flow 200 may be performed by a system, such as a server or other system that include a processor and one or more non-transitory computer-readable mediums. For example, the processing system 140 of FIG. 1 may perform the flow 200.

In some embodiments, the flow 200 may be performed after a webpage is obtained and rendered by a rendering engine, such as the rendering engine 120 of FIG. 1. In these and other embodiments, the webpage may be a search engine results page. In these and other embodiments, the webpage may be obtained in response to a request sent to a website site, such as a search engine. The request may include one or more keywords. Alternately or additionally, profile data may be provided to the website along with the request. The request may be a query or some other request sent to the search engine. In some embodiments, a search engine may be defined as a software system designed to search for information on the World Wide Web. Search engines may typically search the Web based on criteria specified by the user, then provide a list of results that best match the specified criteria.

At block 202, a generative experience box within the webpage may be identified. The generative experience box may be a portion of a webpage that includes an AI response. For example, the generative experience box may include an interactive AI-generated content display that provides dynamic, context-aware, and personalized responses. The generative experience box may include text, images, summaries, or recommendations. The AI response may be analyzed to determine keywords used in the request and/or other keywords that may be tracked.

At block 204, after the generative experience box is identified, a type of results in the generative experience box may be identified and recorded. The types may include places, unordered lists, ordered lists, pros and cons, reviews, shopping results, and carousels, among others. In these and other embodiments, a carousel may include a horizontally scrollable display of content that appears in the webpage. The carousel may allow for quickly browsing multiple items, such as images, articles, videos, or products, without leaving the webpage. The types may be recorded to allow the system to understand what may be included in an AI response given a particular keyword and/or profile data.

At block 206, a main answer provided by the AI response to the request may be identified and recorded. A main answer may be distinguished by its prominence, relevance, and direct applicability to the request. For example, a search results page may include a main answer that is distinguished by its prominence on the page, such as being displayed at the top or in a highlighted box. The main answer may also be distinguished by its direct relevance to the search query and concise presentation of key information responsive to the request.

At block 208, brands mentioned in the AI response may be identified. In some embodiments, a brand may be a distinctive identifier associated with a particular entity, product, or service, which may include names, logos, symbols, slogans, trade dress, or other distinguishing features. A brand may serve to differentiate goods or services from those of competitors and may be recognized through consumer perception, reputation, and market presence.

To identify a brand in AI response, natural language processing may be performed on the text to detect and extract brand names. The natural language processing may involve tokenizing the text into individual words or phrases, applying part-of-speech tagging to identify proper nouns, and using named entity recognition techniques to classify proper nouns as brand names. The processing engine may utilize a pre-defined dictionary or database of known brand names to aid in identification. Additionally, contextual cues and patterns surrounding potential brand mentions may be analyzed to improve accuracy of brand detection. Machine learning models trained on labeled datasets of brand mentions may also be employed to recognize brands based on textual features and context.

At block 210, a sentiment analysis may be performed on the AI response. The sentiment analysis may a sentiment related to different domains identified in the AI response. Sentiment may be a qualitative or quantitative assessment of an expressed attitude, opinion, or emotional tone derived from textual, auditory, or visual aspects in the AI response. In some embodiments, to identify sentiment in an AI response, natural language processing techniques may be applied to analyze the text and determine the overall emotional tone. The natural language processing (NLP) techniques may involve tokenizing the text into individual words, applying part-of-speech tagging, and using sentiment lexicons or machine learning models trained on labeled sentiment data. Key indicators of sentiment may include the presence of positive or negative words, intensifiers, negations, and emotional expressions. The sentiment analysis may evaluate the text at both the sentence and overall response level to determine if the tone is positive, negative, or neutral. Additionally, more nuanced aspects of sentiment such as subjectivity, sarcasm, and implicit sentiment may be detected through advanced NLP models. The results of the sentiment analysis may be quantified on a numerical scale or categorized into discrete sentiment classes as sentiment information.

The flow 200 may be performed for multiple different keywords and/or profile data. As a result, sentiment information, identified brands, answers to questions, and types of results may be collected for multiple different keywords and/or profile data. The sentiment information, identified brands, answers to questions, and types of results may be referred to as data collected from the AI response. In these and other embodiments, after collection of sufficient data, an understanding of the algorithms used by the search engines may be developed regarding what types of keywords and profile data may result in AI responses and information that may be included in the AI responses. The data may be used in a similar manner as the data stored in the data storage 150 of FIG. 1 as described with respect to FIG. 1. Modifications, additions, or omissions may be made to the flow 200 without departing from the scope of the present disclosure.

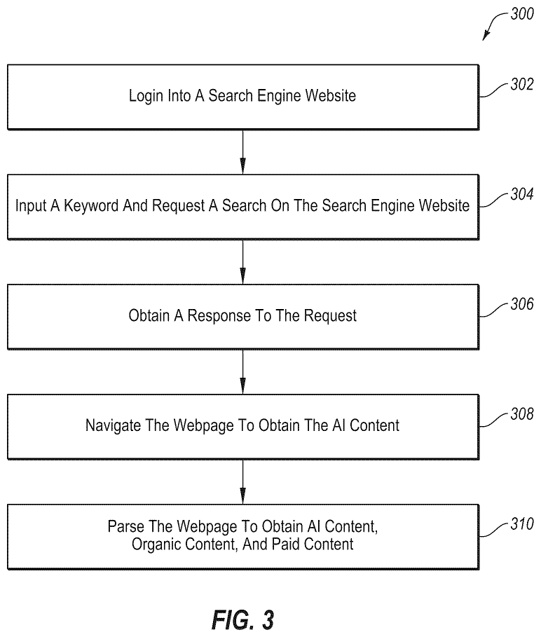

FIG. 3 illustrates a flowchart of an example method 300 for parsing AI content. The method 300 may be arranged in accordance with at least one embodiment described in the present disclosure. One or more operations of the method 300 may be performed, in some embodiments, by a device or system, such as the rendering engine 120 and/or processing system 140 of FIG. 1 or another device or combination of devices. In these and other embodiments, the method 300 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 300 may begin at block 302, where a rendering system, such as a web browser, may login into a search engine website. The rendering system may login using a particular profile. The particular profile may be associated with particular profile data. In these and other embodiments, the rendering system may operate without rendering a visual interface, instead programmatically interacting with the page elements and content to perform the search and retrieve results.

At block 304, the rendering system may input a keyword and request a search on the search engine website. For example, the rendering system may navigate to a search webpage, locate the search input field on the webpage by examining the HTML structure and attributes. After identification, the rendering system may programmatically enter the keyword into the input field. To submit the search, the rendering system may locate and trigger the search button or form submission element. The keyword may be one or more words, images, or sounds or a combination of words, images, and sounds. For example, a keyword may be a phrase such as “best hotels in San Francisco” or “Italian food near me.”

At block 306, the rendering system may obtain a response to the request. The response may be a search results page. In these and other embodiments, the search results page may be provided to the rendering system as instructions for rending the search results page. The rendering system may begin rendering the search results page. In some embodiments, the webpage may be rendered but the AI content may not be loaded. For example, the page may be rendered without the AI content because the AI content is still being generated. As an example, HyperText Markup Language (HTML) or Extensible Markup Language (XML), Cascading Style Sheets (CSS), and primary JavaScript of the webpage may be loaded and ready to be displayed or displayed. Thus, the webpage may be considered rendered even though the AI content is not available. In these and other embodiments, the rendering system may wait for AI content to be obtained and loaded. If the rendering system were to perform an analysis after the rendering of the webpage was completed but before the AI content is loaded, the rendering system may not analyze the AI content. The amount of time to wait for AI content to be obtained and loaded may depend on the expected AI content or other factors, such as those described with respect to FIG. 1.

In some embodiments, the rendering system may first determine that AI content is to be presented. In response to AI content to be presented but not being available, the rendering system may wait for a period of time for the AI response to be loaded. In response to AI content being loaded, the method 300 may proceed to block 308.

At block 308, the webpage may be navigated to obtain the AI content. After the AI content is fully received, the rendering engine may navigate the webpage to interact with the AI content. Interacting with the AI content may involve selecting one or more elements associated with the AI content to expand the AI content. For example, the rendering engine may click on “show more” buttons or follow indicated paths to access additional AI-generated information associated with the query. The rendering engine may also insert and run JavaScript on the webpage to detect and interact with AI content elements. By navigating and interacting with the AI content in this manner, the rendering engine can obtain the full AI-generated response, not just an initial summary or preview. Obtaining the full AI-generated response may allow for capturing a complete image of the fully rendered webpage with all AI content expanded and visible for further processing and analysis.

At block 310, the webpage may be parsed to obtain the AI content, organic content, and paid content. In some embodiments, to various content of AI blocks may be detected. In these and other embodiments, some or each of the different contents detected may be parsed differently. The various content may include answer, images, videos, recipes, local listing, product viewer, reviews, code block, comparison, and warnings, among others. The information regarding the construct of the webpage may include a percent of the webpage that is AI content, organic content, and paid content. The information may be used in a similar manner as the data stored in the data storage 150 of FIG. 1 as described with respect to FIG. 1.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

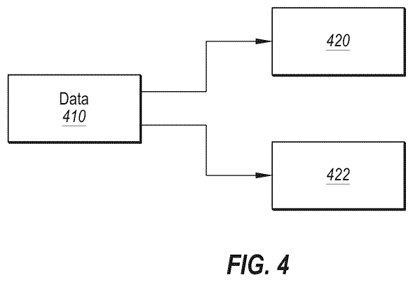

FIG. 4 illustrates a flow diagram 400 that may illustrate how collected data 410 may be used. For example, the data 410 may be the data collected from FIG. 2 and FIG. 3. For example, the data may include what percent of the webpage that is AI content, organic content, and paid content. Alternately or additionally, the data may include sentiment information, identified brands, answers to questions, and types of results as described with respect to FIG. 2.

The data 410 may be provided to a reporting system 420. The reporting system 420 may include one or more software platforms that identify, categorize, or report instances or metrics such as rank, volume, placement, share, conversion, site audit, and/or compliance, for online content. For example, the platform may be a search engine optimization platform.

The data 410 may also be provided to a recommendation/optimization system 422. The recommendation/optimization system 422 may include software platforms that either generate optimization recommendations or that execute optimizations (software automated, with or without user approvals) SEO, social media, CMS, CMP, marketing automation, digital ads, A/B Testing, site search, chatbot, ecommerce, video/image, document management.

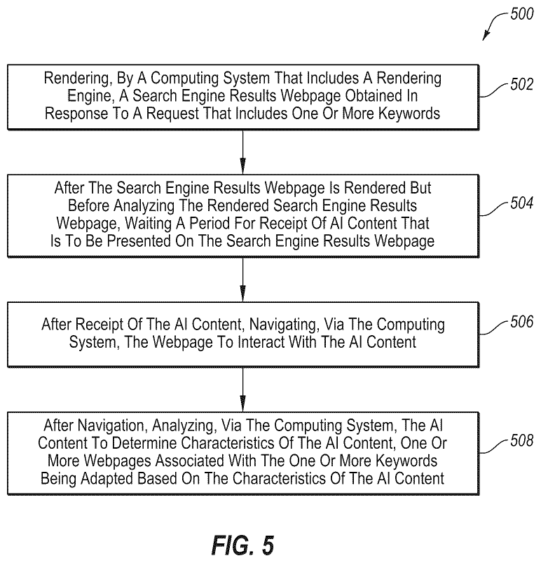

FIG. 5 illustrates a flowchart of an example method 500 to parse search results. The method 500 may be arranged in accordance with at least one embodiment described in the present disclosure. One or more operations of the method 500 may be performed, in some embodiments, by a device or system, such as the analysis system 112 of FIG. 1 or another device or combination of devices. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, rendering, by a computing system that includes rendering engine, a search engine results webpage obtained in response to a request that includes one or more keywords.

At block 504, after search engine results webpage is rendered but before analyzing the rendered search engine results webpage, waiting a period for receipt of AI content that is to be presented on the search engine results webpage.

At block 506, after receipt of the AI content, navigating, via the computing system, the webpage to interact with the AI content.

At block 508, after navigation, analyzing, via the computing system, the AI content to determine characteristics of the AI content, one or more webpages associated with the one or more keywords being adapted based on the characteristics of the AI content.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

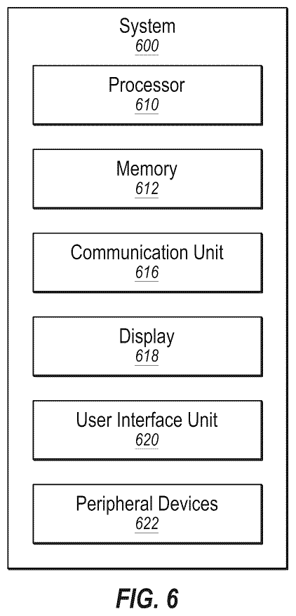

FIG. 6 illustrates an example system 600 that may be used during transcription presentation. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure.

For example, the system 600 may be part of the rendering engine 120 of FIG. 1 and may be configured to perform one or more of the tasks described above with respect to the rendering engine 120. As another example, the system 600 may be part of the analysis system 112 of FIG. 1 and may be configured to perform one or more of the tasks described above with respect to the analysis system 112 of FIG. 1.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to parsing search results such that the system 600 may perform or direct the performance of the operations associated therewith as directed by the instructions. In these and other embodiments, the instructions may be used to perform the method 500 of FIG. 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present video, text captions, user interfaces, and other data as directed by the processor 610.

The user interface unit 620 may include any device to allow a user to interface with the system 600. For example, the user interface unit 620 may include a mouse, a track pad, a keyboard, buttons, camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices. In these and other embodiments, the microphone may be configured to capture audio. The imager may be configured to capture images. The images may be captured in a manner to produce video or image data. In some embodiments, the speaker may broadcast audio received by the system 600 or otherwise generated by the system 600.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method of parsing search results, the method comprising:
rendering, by a computing system that includes rendering engine, a search engine results webpage obtained in response to a request that includes one or more keywords;
after search engine results webpage is rendered but before analyzing the rendered search engine results webpage, waiting a period for receipt of AI content that is to be presented on the search engine results webpage;
after receipt of the AI content, navigating, via the computing system, the webpage to interact with the AI content; and
after navigation, analyzing, via the computing system, the AI content to determine characteristics of the AI content, one or more webpages associated with the one or more keywords being adapted based on the characteristics of the AI content.

2. The method of claim 1, wherein navigating the webpage to interact with the AI content include interacting with the AI content to allow AI views to be fully presented.

3. The method of claim 1, wherein the period is determined based on historical times to receive AI content.

4. The method of claim 1, further comprising:
parsing an image of the webpage that includes the AI content; and
determining an amount of the webpage that is covered by different aspects of the webpage, wherein the one or more webpages are adapted based on the amount of the webpage that is covered by different aspects of the webpage.

5. The method of claim 4, wherein the different aspects of the webpage comprise one or more of: the AI content; organic search results; paid search results; social media posts; or images.

6. The method of claim 1, wherein the characteristics of the AI content includes the AI content indicating: a place; a business; a particular store of a business; an unordered list; an ordered list; pros and cons related to the request; reviews; or a shopping carousel.

7. The method of claim 1, wherein analyzing the AI content to determine characteristics of the AI content includes determining one or more of: a type of the AI content, one or more brands mentioned in the AI content, and a sentiment of the AI content.

8. A non-transitory computer-readable medium configured to store instructions which when executed cause a system to perform operations comprising:
rendering, by a computing system that includes rendering engine, a search engine results webpage obtained in response to a request that includes one or more keywords;
after search engine results webpage is rendered but before analyzing the rendered search engine results webpage, waiting a period for receipt of AI content that is to be presented on the search engine results webpage;
after receipt of the AI content, navigating, via the computing system, the webpage to interact with the AI content; and
after navigation, analyzing, via the computing system, the AI content to determine characteristics of the AI content, one or more webpages associated with the one or more keywords being adapted based on the characteristics of the AI content.

9. The computer-readable medium of claim 8, wherein navigating the webpage to interact with the AI content include interacting with the AI content to allow AI views to be fully presented.

10. The computer-readable medium of claim 8, wherein the period is determined based on historical times to receive AI content.

11. The computer-readable medium of claim 8, wherein the operations further comprise:
parsing an image of the webpage that includes the AI content; and
determining an amount of the webpage that is covered by different aspects of the webpage, wherein the one or more webpages are adapted based on the amount of the webpage that is covered by different aspects of the webpage.

12. The computer-readable medium of claim 11, wherein the different aspects of the webpage comprise one or more of: the AI content; organic search results; paid search results; social media posts; or images.

13. The computer-readable medium of claim 8, wherein the characteristics of the AI content includes the AI content indicating: a place; a business; a particular store of a business; an unordered list; an ordered list; pros and cons related to the request; reviews; or a shopping carousel.

14. The computer-readable medium of claim 8, wherein analyzing the AI content to determine characteristics of the AI content includes determining one or more of: a type of the AI content, one or more brands mentioned in the AI content, and a sentiment of the AI content.

15. A system comprising:
one or more processors; and
one or more non-transitory computer-readable medias configured to store instructions which when executed by the one or more processors cause the system to perform operations comprising:
rendering, by a computing system that includes rendering engine, a search engine results webpage obtained in response to a request that includes one or more keywords;
after search engine results webpage is rendered but before analyzing the rendered search engine results webpage, waiting a period for receipt of AI content that is to be presented on the search engine results webpage;
after receipt of the AI content, navigating, via the computing system, the webpage to interact with the AI content; and
after navigation, analyzing, via the computing system, the AI content to determine characteristics of the AI content, one or more webpages associated with the one or more keywords being adapted based on the characteristics of the AI content.

16. The system of claim 15, wherein navigating the webpage to interact with the AI content include interacting with the AI content to allow AI views to be fully presented.

17. The system of claim 15, wherein the period is determined based on historical times to receive AI content.

18. The system of claim 15, wherein the operations further comprise:
parsing an image of the webpage that includes the AI content; and
determining an amount of the webpage that is covered by different aspects of the webpage, wherein the one or more webpages are adapted based on the amount of the webpage that is covered by different aspects of the webpage.

19. The system of claim 18, wherein the different aspects of the webpage comprise one or more of: the AI content; organic search results; paid search results; social media posts; or images.

20. The system of claim 15, wherein the characteristics of the AI content includes the AI content indicating: a place; a business; a particular store of a business; an unordered list; an ordered list; pros and cons related to the request; reviews; or a shopping carousel.
